(19) United States
(12) Patent Application Publication
(10) Pub. No.: US 2011/0200121 A1
(43) Pub. Date: Aug. 18, 2011

(54) Method and System for a Light-Weight Tablet Computing Device

(76) Inventors: Mario Costa, Davie, FL (US); Steven Geffin, N. Miami Beach, FL (US); Charles Peters, St. Louis, MO (US)

(21) Appl. No.: 13/080,863

(22) Filed: Apr. 6, 2011

Related U.S. Application Data
(63) Continuation-in-part of application No. 12/533,050, filed on Jul. 31, 2009.

(51) Int. Cl. H04N 7/26

(52) U.S. Cl. 375/240.26; 375/E07.026

(57) ABSTRACT

Methods and systems provide the wireless use of a desktop computer through a lightweight long-range mobile computing device with extended battery life and no writeable or user-accessible persistent data storage, such as a hard drive, which could be detrimental if lost. The light-weight mobile computing may not run a full operating system, thereby reducing overhead and increasing speed. The mobile computing device provides mobility while providing access to information on a desktop computer. Since some components of conventional laptops are not needed, it may be smaller and/or have lighter weight, and provide extended battery life, while providing greater security by avoiding the risk of data loss. These systems provide a lightweight mobile wireless KVM device (e.g., a small “notebook” computing device or tablet computer device) to connect to desktop computers. These lightweight, mobile computing devices may provide “instant on” capabilities avoiding the start up time of normal laptop computers.

### RELATED APPLICATION

This application is a Continuation-in-Part of and claims benefit to U.S. patent application Ser. No. 12/533,050 entitled “Method and System for a Light-Weight Mobile Computer Device” filed on Jul. 31, 2009, which is incorporated by reference herein.

### FIELD OF THE INVENTION

This generally relates to mobile computing and more particularly to light-weight mobile computing devices wirelessly connected to desktop computers.

### BACKGROUND

Systems exist to facilitate remote control of and access to a computer by an operator at a remote station. Such systems typically use a device or mechanism that enables an operator at a remote station to control aspects of a so-called target (or local) computer. More particularly, such systems typically allow a remote station to provide mouse and keyboard input to the target computer and further allow the remote station to view the video display output, and hear the audio output of the target computer. These types of systems are typically called keyboard-video-mouse (KVM) systems. However, typical conventional KVM systems are not portable or mobile.

Conventional desktop computers, although potentially powerful devices, lack mobility and restrict use of the computer to a single location. Given mobility and travel needs of modern computer users, this limitation is a particular drawback in many situations.

Conventional laptop computers, while mobile, typically do not provide easy access to information that may be stored on a user's desktop computer. Furthermore, they typically lack security because, if they are lost, the information stored on them is also lost and may be compromised. This can be a serious detriment in particular markets with sensitive information requirements such as government, security, and financial areas. Additionally, the computing power used by many conventional laptops reduces the battery usage life for use away from a user's office or a power source. Also, mobility may be hampered by the size requirements of the processing capabilities of conventional laptops.

Conventional laptops also typically do not provide the ability to connect to several computer systems (one-to-many), based on configurable permissions, from a single mobile device. Accordingly, there is a desire to avoid these and other related problems. There is also a desire for a mobile computing system with access to information stored on a desktop computer, while avoiding many of the associated problems with conventional laptop computers.

### SUMMARY

In accordance with methods and systems consistent with the present invention, a data processing system is provided having a target computer and a tablet computing device wirelessly connected to the target computer. The target computer comprises a processor configured to connect the target computer with the tablet computing device over a wireless network, and a video compression component configured to receive and compress video data. The target computer also comprises a network interface configured to send the compressed video data to the tablet computing device over the wireless network, and a persistent storage configured to store data. The tablet device comprises a processor configured to wirelessly connect with the target computer, access the data stored in the persistent storage on the target computer, and display the video data received from the target computer. The tablet computing device also comprises a wireless network interface configured to receive the compressed video data from the target computer over the wireless network, and a video decompression component configured to receive and decompress the compressed video data received from the target computer. Furthermore, the tablet computing device comprises a display configured to display the video data decompressed by the video decompression component.

In accordance with one implementation, a tablet computing device in a KVM data processing system is provided comprising a processor configured to wirelessly connect with a target computer, access data stored in persistent storage on the target computer and display video data from the target computer. The tablet computing device further comprises a wireless network interface configured to receive compressed video data from the target computer, a video decompression component configured to receive and decompress the compressed video received from the target computer, and a display configured to display the video data decompressed by the video decompression component.

In another implementation, a method in a KVM data processing system having a tablet computing device is provided comprising connecting a tablet computing device having no writeable persistent storage with a target computer having writeable persistent storage over a wireless network, and receiving compressed video data from the target computer over the wireless network. The method further comprises decompressing the received compressed video data, displaying the decompressed video data on a display on the tablet computing device, and accessing, by the tablet computing device, the writeable persistent storage on the target computer over the wireless network.

### BRIEF DESCRIPTION OF THE DRAWINGS

FIG. 1 illustrates depicts an exemplary KVM computer system in accordance methods and systems consistent with the present invention.

FIG. 2 illustrates an exemplary target desktop computer system consistent with systems and methods consistent with the present invention.

FIG. 3 depicts a mobile computing device in accordance with methods and systems consistent with the present invention.

FIG. 4 depicts exemplary steps in a method for connecting a mobile computing device to a target desktop computer for use in accordance with methods and systems consistent with the present invention.

### DETAILED DESCRIPTION

Methods and systems in accordance with the present invention provide the wireless use of a desktop computer through a lightweight long-range mobile computing device with extended battery life and no writeable or user-accessible persistent data storage, such as a hard drive, which could be detrimental if lost. In one implementation, the light-weight mobile computing device does not run a full operating system, thereby reducing overhead and increasing speed.

The mobile computing device provides mobility while also providing access to information on a desktop computer. These systems provide a lightweight mobile wireless KVM device (e.g., a small “notebook” computing device or tablet computer device) to connect to desktop computers. Since some typical components of conventional laptops are not needed, it also may be smaller and/or have lighter weight, and provide extended battery life, while providing greater security by avoiding the risk of data loss. These lightweight, mobile computing devices may provide “instant on” capabilities avoiding the start up time of normal laptop computers.

In one implementation, the lightweight mobile wireless device acts as a mobile KVM device and does not have writeable or user-accessible permanent storage such as a hard drive. In another implementation, a mobile computing device does not include a full normal operating system, but rather a smaller operating system such as embedded Linux that does not have a user interface. The operating system is primarily responsible for launching the connection application upon power up.

In accordance with one implementation, a light-weight mobile wireless KVM device comprises a keyboard, a video screen, a mouse, sound, and a wireless network interface. It may also include, for example, Virtual Media (from Avocent, Inc.) which facilitates access to storage media such as CD-ROMs, flash memory, and external drives anywhere on a network. These mobile computing devices may be lightweight, have an extended battery life (e.g., 8-10 hour battery life), and minimal network bandwidth and speed requirements. Further, they provide a secure connection back to the desktop while minimizing desktop resource overhead. In some implementations, the lightweight mobile computer device may be a tablet computer such as or similar to an iPad from Apple, Inc. In these implementations, the tablet computing device may not a physical keyboard or mouse and may receive user input on the screen.

In the discussion that follows, the computer or system being controlled or accessed is generally referred to as the target computer or the target system. In some instances, the target computer is also referred to as the local computer. The system that is being used to access or control the target computer is generally referred to herein as the client system.

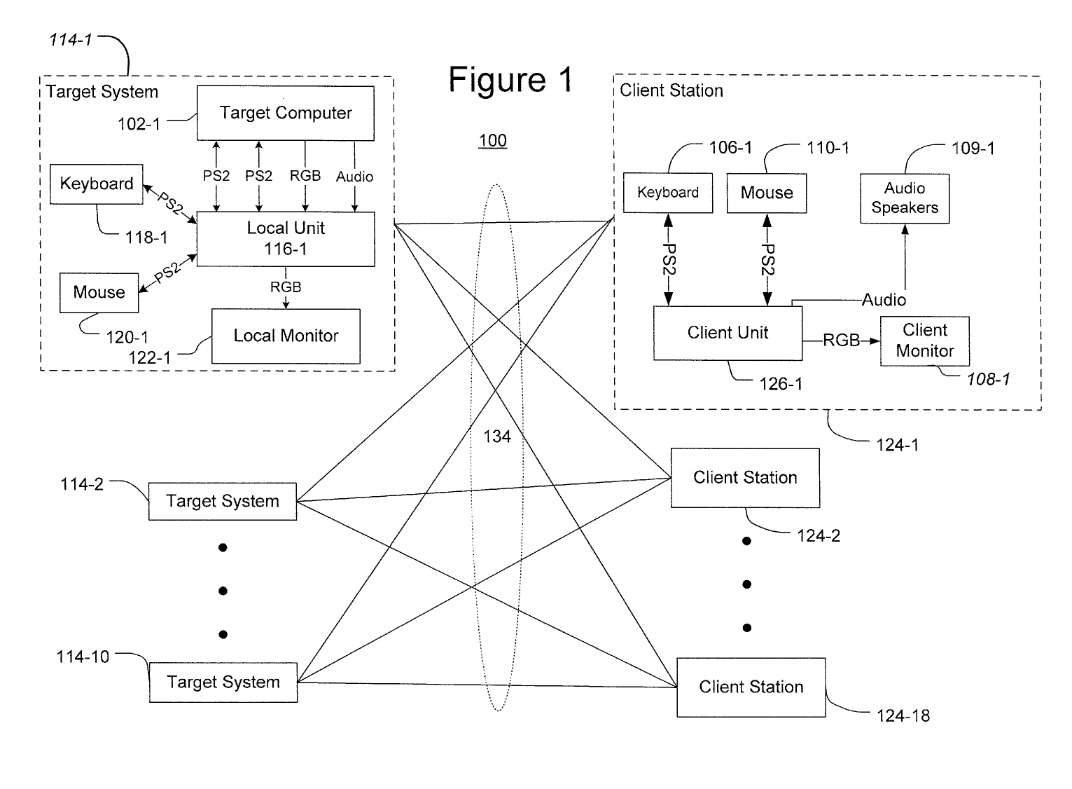

FIG. 1 illustrates depicts an exemplary KVM computer system in accordance methods and systems consistent with the present invention. A KVM system 100 is shown in FIG. 1, where one or more target systems 114-1 . . . 114-10 are controlled or accessed by one or more client stations 124-1, 124-2, . . . , 124-18 (generally 124). Each target system 114 includes a target computer 102 with associated and attached local unit 116. Each client station 124 generally includes a client unit 126, a keyboard 106, a video monitor 108, audio speakers 109 and a mouse (or similar point-and-click device) 110, although some client stations may only include a video display 108 and a client unit, or audio speakers 109 and a client unit. Operation of a particular target computer 102-i may be remotely viewed on the video monitor 108 of any of the client stations 124, the audio heard on the speakers 109 of a client station, and the keyboard 106 and mouse 110 of the client station 124 may be used to provide keyboard and mouse input to the target computer 102-i. As shown in FIG. 1, in a KVM system 100, a client station 124 is able to control or access more than one target computer. Note that the lines drawn between target systems 114 and client stations 124 in FIG. 1 represent potential (and not necessarily actual) wired or wireless (e.g., RF) links between those sides. Thus, each target computer 102 may be controlled or accessed by more than one client station 124, and each client station 124 may control more than one target computer 102.

Furthermore, in certain contexts, the target system is considered to be a video transmitter or sending unit, and the client system is the video receiving unit or receiver, although both units transmit and receive. Generally, video and audio travel from target system to client station, while keyboard and mouse data move from client station to target system.

As shown in FIG. 1 the local or target system 114 includes a target computer 102 and an associated local unit 116. The local system 114 may also include a keyboard 118, a mouse (or other point-and-click-type device) 120 and a local monitor 122, each connected to the local unit 116 directly. The client station 124 includes a client unit 126. The local or target computer 102 may be a computer, a server, a processor or other collection of processors or logic elements. Generally, a target computer 102 may include any processor or collection of processors. By way of example, a target computer 102 may be a processor or collection of processors or logic elements located (or embedded) in a server, a desktop computer (such as a PC, Apple Macintosh or the like), a kiosk, an ATM, a switch, a set-top box, an appliance (such as a television, DVR, DVD player and the like), a vehicle, an elevator, on a manufacturing or processing production line. A collection of target computers 102 may, e.g., be a collection of servers in a rack or some other collection; they may be independent of each other or connected to each other in a network or by some other structure. The local and client monitors 122, 108, may be digital or analog.

The local unit 116 is a device or mechanism, e.g., a printed circuit board (“PCB”), which is installed locally to the target/local computer 102. This device may be close to, but external to the computer, or may be installed inside the computer's housing. Regardless of the positioning of the local unit 116, in one implementation, there is a direct electrical connection between the target computer 102 and the local unit 116.

Various components on the local/target system 114 communicate wirelessly or via a wired connection with components on the client station 124 via a wireless connection link 134. In one implementation, the wireless connection or link 134 follows the IEEE 802.11g standard protocol or 3G wireless protocol, although one skilled in the art will realize that other protocols and methods of communication are possible.

The local unit 116 receives local mouse and keyboard signals, e.g., as PS2 or USB signals. These signals are provided by the local unit 116 to the target computer 102. The target computer 102 generates video output signals, e.g., RGB (Red, Green, Blue) signals, which are provided to the local unit 116 which, in turn, provides the signals to drive the local monitor 122. The target computer 102 may also generate audio output signals which are provided to the local unit 116. As noted, the target computer 102 need not have a keyboard, mouse or monitor, and may be controlled entirely by a client station 124.

Local unit 116 transmits image and audio data for transmission to a client station (e.g., via client unit 126). Some or all of the data may be compressed before being transmitted. Additionally, local unit 116 may receive mouse and keyboard data (from a client station 124), which is then provided to the local/target computer 102. The target computer 102 may execute the data received and may display output on its local monitor 122.

The client station 124 receives video data from the local unit 116 of the target computer 102, via a wired or wireless connection (e.g., 802.11g or 3G wireless connection 134). The client unit 126 receives (possibly compressed) video and audio data (not all of the data need be compressed) from the local unit 116. The client unit 126 decompresses (as necessary) the video and audio data from the local unit 116 and provides it to the appropriate rendering device, e.g., to the client monitor 108, which displays the video data, and to the client speakers 109, respectively. Additionally, client mouse 110 and keyboard 106 may be used to generate appropriate signals (e.g., PS2 signals, USB signals) that may be transmitted via client unit 126 to local unit 116 for execution on target computer 102. The client stations 124 in the network may be mobile computing devices 300 (described further below), which are typically mated to one target desktop computer 102, but may be mated to more than one.

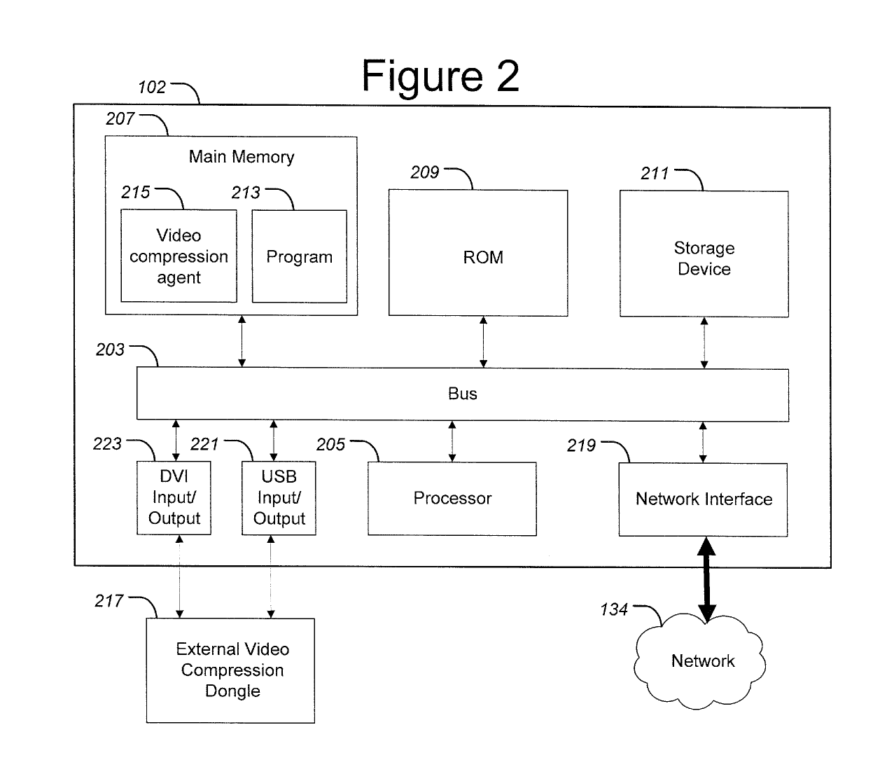

FIG. 2 illustrates an exemplary target desktop computer system consistent with systems and methods consistent with the present invention. Target computer 102 includes a bus 203 or other communication mechanism for communicating information, and a processor 205 coupled with bus 203 for processing the information. The mobile computing device 300 may also include similar components as target computer 102, including some of the components mentioned, but does not include writeable or user-accessible persistent storage or a full operating system. Target computer 102 also includes a main memory 207, such as a random access memory (RAM) or other dynamic storage device, coupled to bus 203 for storing information and instructions to be executed by processor 205. In addition, main memory 207 may be used for storing temporary variables or other intermediate information during execution of instructions to be executed by processor 205. Main memory 207 includes a program 213 for implementing processing consistent with methods and systems in accordance with the present invention. Target computer 102 further includes a Read-Only Memory (ROM) 209 or other static storage device coupled to bus 203 for storing static information and instructions for processor 205. A storage device 211, such as a magnetic disk or optical disk, is provided and coupled to bus 203 for storing information and instructions.

According to one embodiment, processor 205 executes one or more sequences of one or more instructions contained in main memory 207. Such instructions may be read into main memory 207 from another computer-readable medium, such as storage device 211. Execution of the sequences of instructions in main memory 207 causes processor 205 to perform processes described herein. One or more processors in a multi-processing arrangement may also be employed to execute the sequences of instructions contained in main memory 207. In alternative embodiments, hard-wired circuitry may be used in place of or in combination with software instructions. Thus, embodiments are not limited to any specific combination of hardware circuitry and software.

Although described relative to main memory 207 and storage device 211, instructions and other aspects of methods and systems consistent with the present invention may reside on another computer-readable medium, such as a floppy disk, a flexible disk, hard disk, magnetic tape, a CD-ROM, magnetic, optical or physical medium, a RAM, a PROM, and EPROM, a FLASH-EPROM, any other memory chip or cartridge, or any other medium from which a computer can read, either now known or later discovered.

In exemplary systems using these mobile computing devices 300, two components are provided for video processing: a first component which efficiently compresses video from the desktop target computer 102, and a second component that decompresses the video at the remote light-weight mobile computing device. The target desktop computer 102 includes a video compression software agent 215 that compresses video on systems that do not include an external dongle 217 for video compression. This video compression software agent 215 compresses video, and sends the video to the network interface 219 to be sent to the mobile computing device 300. In the case of the use of the external dongle 217, the software agent 215 receives the compressed video from the dongle and sends the compressed video to the network interface 219 to be sent to the mobile computing device 300.

Plugged into the target desktop computer 102, a dongle 217 or other type of external hardware video compression component may be used for video compression so that it does not need to be done in software on the target desktop computer 102. By using video compression protocols such as Dambrackas Video Compression (DVC) protocol and communication protocols such as Avocent Video Session Protocol (AVSP), providing this external hardware video compression component 217 can significantly reduce resource overhead. This external video compression component 217 connects to a DVI interface 223 on the target computer 102 to receive video, and feeds back into the target desktop computer 102 through a USB port 221 to return compressed video. The software agent 215 extracts the DVC compressed video and makes it available to the remote mobile device through the network interface 219.

For security, the dongle 217 provides a unique identification number paired to a corresponding identification in the remote mobile computing device 300. This provides a layer of security by guaranteeing a secure point-to-point connection between the mobile computing device 300 and the dongle 217. If the mobile computing device 300 is lost or stolen, in one implementation, it would require a new dongle 217.

The above implementation describes the use of an external USB component (e.g., dongle 217), but however, other implementations are possible. For example, this external component may be built into desktops/laptops for ease of use and higher security. Another implementation of the mobile computing device system is composed of two mated parts: the light-weight mobile computing device 300 and a computer base docking station comprising components of a desktop/laptop (CPU, memory, network, etc.) except for the KVM components such as the keyboard, video and mouse. When the mobile computing device 300 is mated with the base docking station, the functionality provided to the user is similar to that of a normal desktop/laptop. When the user needs to be mobile or remote from his office, the mobile computing device 300 may be detached, thus providing remote access to the user's base station (including the hard drive and applications) via the wireless mobile computing device.

The connection to the mobile computing device 300 may be any connection such as WAN, LAN, 802.11, 3G or any other wireless network. A management gateway controls the connection, and assigns and tracks IP addresses for the computers. When turned on, the mobile computing device 300 sends a message to the gateway to connect to the target desktop computer 102, and the gateway performs the routing. The gateway may be a regular server or PC. In addition, there may be additionally security features added for the connection between at the mobile computing device 300 and the target desktop computer 102.

In other implementations, the wireless network interface 219 can be mated with various devices, such as (1) a desktop or laptop computer via an external USB dongle 217, (2) a desktop or laptop computer via an internal chip (e.g., possibly part of a baseboard management controller (BMC)), 3) a computer base docking station (comprising of components of a desktop or laptop computer except for the KVM components), 4) a KVM switch, and 5) any other suitable device.

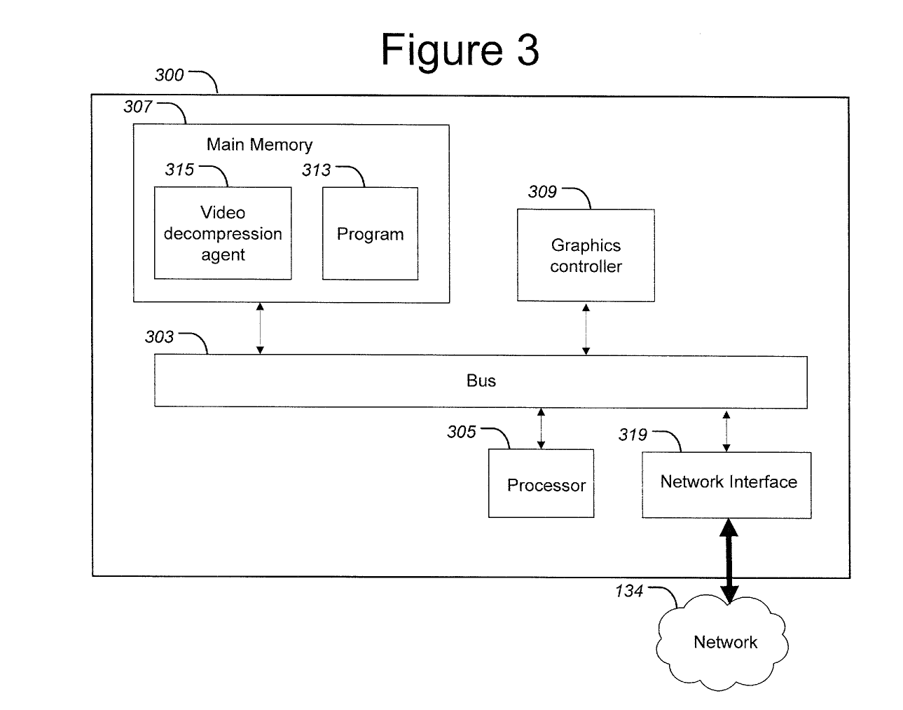

FIG. 3 depicts a mobile computing device 300 in accordance with methods and systems consistent with the present invention. The mobile computing device 300 includes a processor 305, a volatile memory 307 such as RAM, a video decompression software agent 315, a graphics control component 309, and one or more network interfaces 319 such as wireless 802.11 radio module and/or a 3G wireless interface. It may also include a keyboard 106, mouse 110 and video display 108, as well as other peripheral components. In one implementation, it does not have a full operating system and no writeable persistent storage. In one implementation, the mobile computing device may be a tablet computing device and may take user input on the screen of the device 300. In this implementation, the device 300 may have a virtual keyboard implemented on the screen of the device. The operating system and application to connect the mobile computing device 300 to the target computer 102 may be stored on a ROM, but the mobile computing device has no hard drive, for example, or other persistent storage. The processor 305 may be a small, low-power embedded processor which supports various communications protocols including, for example, Wi-Fi and 3G communication interfaces. The embedded processor 305 also controls the video decompression, keyboard, mouse, sound and Virtual Media support. The mobile computing device 300 may also include an operating application program for controlling operations of the mobile computing device, and may include, for example, Virtual Media.

On the mobile computing device 300, the received DVC compressed video is decompressed and written to a frame buffer (not shown). However, other compression protocols may be used. The frame buffer video is then sent though the graphics control component 309 to a video display, such as a TMDS flat-panel display, and to a digital to analog (D/A) converter (not shown) that makes the video available externally, via a VGA connector for example, for display on a second monitor or overhead projector.

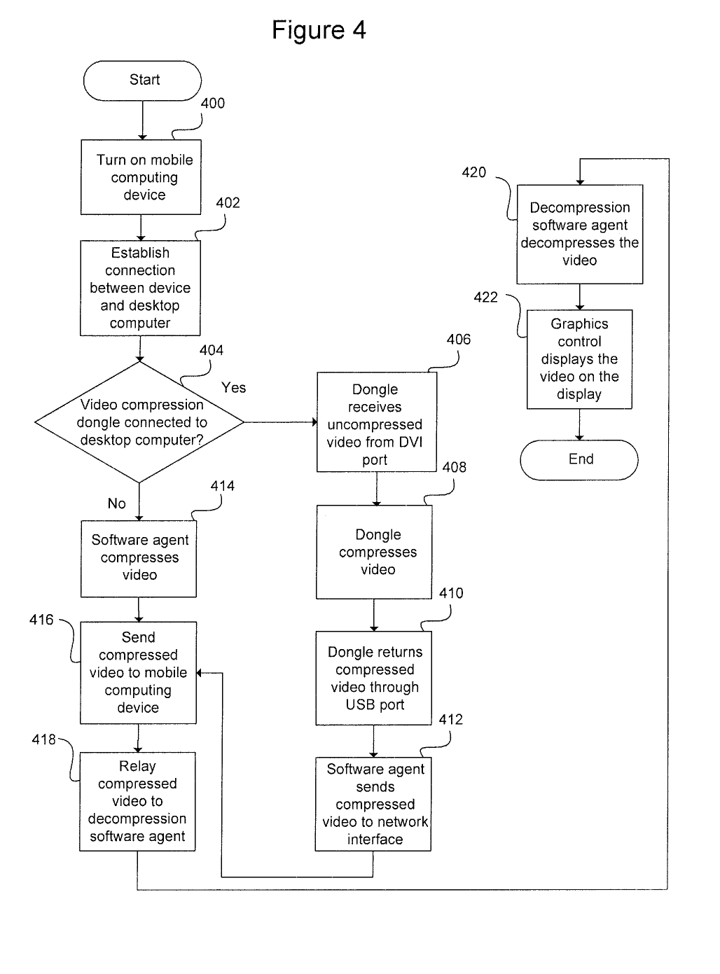

FIG. 4 depicts exemplary steps in a method for connecting a mobile computing device 300 to a target desktop for use in accordance with methods and systems consistent with the present invention. First, a user turns the mobile computing device 300 on (step 400). The mobile computing device 300 starts up quickly in an “instant on” manner. Upon startup the mobile computing device 300 establishes a connection to the target desktop computer 102 via the gateway (step 402). If the target desktop computer 102 has a video compression dongle 217 (step 404), the dongle receives video to be sent to the mobile computing device 300 through the target desktop computer's DVI interface 223 (step 406). The dongle 217 then compresses the video using any suitable compression protocol, such as DVC (step 408). The compressed video is sent through a USB port 221 to the video compression software agent 215 (step 410) on the mobile computing device 300 to be relayed to the network interface 219 for transmission (step 412).

If there is no video compression dongle 217 (step 404), the video compression software agent 215 on the target desktop computer 102 compresses video to be sent to the mobile computing device 300 (step 414). The video compression software agent 215 sends the compressed video to the network interface 219 for transmission to the mobile computing device 300 (step 416).

Next, the mobile computing device's network interface 319 receives the transmission and relays it to the decompression component on the mobile computing device 300 (step 418). The decompression component decompresses the compressed video (step 420), and then sends it to the graphics control component 309 to be displayed on the mobile display (step 422).

The foregoing description of various embodiments provides illustration and description, but is not intended to be exhaustive or to limit the invention to the precise form disclosed. Modifications and variations are possible in light of the above teachings or may be acquired from practice in accordance with the present invention. It is to be understood that the invention is intended to cover various modifications and equivalent arrangements included within the spirit and scope of the appended claims.

What is claimed is:

1. A data processing system having a target computer and a tablet computing device wirelessly connected to the target computer, comprising:
the target computer comprising:
a processor configured to connect the target computer with the tablet computing device over a wireless network;
a video compression component configured to receive and compress video data;
a network interface configured to send the compressed video data to the tablet computing device over the wireless network;
a persistent storage configured to store data; and
the tablet computing device comprising:
a processor configured to:
wirelessly connect with the target computer;
access the data stored in the persistent storage on the target computer; and
display the video data received from the target computer;
a wireless network interface configured to receive the compressed video data from the target computer over the wireless network;
a video decompression component configured to receive and decompress the compressed video data received from the target computer; and
a display configured to display the video data decompressed by the video decompression component.

2. The data processing system of claim 1, wherein the video compression component is a dongle physically connected to the target computer.

3. The data processing system of claim 2, wherein the dongle sends the compressed video data to the target computer through a USB connection.

4. The data processing system of claim 1, wherein the dongle receives the compressed video data from the target computer through a DVI connection

5. The data processing system of claim 1, wherein tablet computing device is an instant-on tablet computing device.

6. The data processing system of claim 1, wherein the video compression component is software.

7. The data processing system of claim 1, wherein the tablet computing device comprises no hard drive.

8. The data processing system of claim 7, wherein the tablet computing device comprises writeable no persistent storage of data.

9. The data processing system of claim 1, wherein the compressed video is compressed and decompressed with the DVC compression protocol.

10. The data processing system of claim 1, wherein the wireless network interface receives the compressed video over a Wi-Fi network.

11. The data processing system of claim 1, wherein the wireless network interface receives the compressed video over a 3G network.

12. The data processing system of claim 1, wherein the target computer is a desktop personal computer.

13. A tablet computing device in a KVM data processing system, comprising:
a processor configured to wirelessly connect with a target computer, access data stored in persistent storage on the target computer and display video data from the target computer;
a wireless network interface configured to receive compressed video data from the target computer;
a video decompression component configured to receive and decompress the compressed video received from the target computer; and
a display configured to display the video data decompressed by the video decompression component.

14. The tablet computing device of claim 1, wherein the tablet computing device comprises no writeable persistent storage.

15. The tablet computing device of claim 1, wherein the tablet computing device comprises an operating system with no user interface.

16. The tablet computing device of claim 1, wherein the compressed video is compressed and decompressed with the DVC compression protocol.

17. The tablet computing device of claim 1, wherein the wireless network interface receives the compressed video over a Wi-Fi network.

18. The tablet computing device of claim 1, wherein the wireless network interface receives the compressed video over a 3G network.

19. The tablet computing device of claim 1, wherein the target computer is a desktop personal computer.

20. A method in a KVM data processing system having a tablet computing device, comprising:
connecting a tablet computing device having no writeable persistent storage with a target computer having writeable persistent storage over a wireless network;
receiving compressed video data from the target computer over the wireless network;
decompressing the received compressed video data;
displaying the decompressed video data on a display on the tablet computing device; and
accessing, by the tablet computing device, the writeable persistent storage on the target computer over the wireless network.
